(19) United States
(12) Patent Application Publication
(10) Pub. No.: US 2019/0242360 A1
(43) Pub. Date: Aug. 8, 2019

(54) RADIAL REACTION WIND TURBINE ENGINE / POWERPLANT / KUMARS RR VT ENGINE

(71) Applicant: Sukumaran BALAMUNIANDY, Sungai Buloh (MY)

(72) Inventor: Sukumaran BALAMUNIANDY, Sungai Buloh (MY)

(21) Appl. No.: 16/341,860

(22) PCT Filed: Oct. 12, 2016
(86) PCT No.: PCT/MY2016/000063

§ 371 Date: Apr. 12, 2019

(51) Int. Cl. F03D 3/04; F03D 3/00; F03D 3/06

(52) U.S. Cl. CPC F03D 3/0409; F03D 3/002; F03D 3/005; F05B 2240/40; F05B 2240/21; F05B 2250/25; F05B 2240/12; F03D 3/061

(57) ABSTRACT

A compact self contained Engine using wind power to generate electricity. Each engine is able to operate 2 generators simultaneously. It is possible to install multiple units of the engine for large scale commercial use.

### TECHNICAL FIELD

This Engine is a field installation to harness Kinetic Energy from wind and convert it to Electrical Energy.

### BACKGROUND ART

With serious view of the present circumstance of global warming scenario, a cheap and clean source of energy has to be identified. It also has to be a sustainable and renewable source. The answer is Wind Power.

For ages, Humans have harnessed the energy from wind to carry out mechanical work. The precursor had been the windmill, which was used to grind wheat and draw water from canals amongst others.

Recent years, there have been an increasing interest and innovations with regards to Electrical Energy derived from Wind Turbines. The most common ones found worldwide is the wind towers fitted with propeller blades. The size of these towers and their blades are gigantic. The costs of constructing these wind turbine towers are exorbitant. This defeats the idea of cheap energy, whereby the costs of building them is passed on to the consumers. It is a mammoth task to build them and cumbersome to maintain. One generator is coupled to one set of propellers. Hence, one tower one power generator.

Novelty designs have also been introduced recently, which seems to be artistic in nature than to serve the actual purpose.

### DISCLOSURE OF INVENTION

This invention which I consider as the Rolls Royce of all wind turbine engines meets the rigors of very high expectations. Two generators can be operated simultaneously from a single engine unit.

The concept employed to develop this engine is based on:—
(a) Bernoulli's Principle—employing the close relationship of pressure and velocity of air over profiled contours and passage through constricted paths of varying surface areas. and
(b) A modified Archimedes screw employing the arctangent design function to generate the spiral blade. The single continuous blade is attached to the rotor of the turbine at angles of 45 to 90 degrees.

Combining (a) and (b) stated above, it is possible to create a vortex like flow of air around the rotor. The pitch of the blade on the turbine rotor is varying i.e. ascending/descending thus allowing the generation of a pressure gradient. This design feature forces the air between the walls of the blade.

The basic components of Kumars RR VT Engine are:—

### (1) Duct/Housing Assembly

The housing of the engine which henceforth will be referred to as the duct, allows the passage of air through it's open ends. The ceiling and the base of the duct are attachment points for 2 aerofoils. The sidewalls also act as supports for the turbine rotor, shaft, journals and bearings.

### (2) Turbine Rotor, Blade and Shaft Assembly

The rotor acts as the base for attachment of the blade and end plates. It is also the housing for the turbine shaft.

The single continuous blade placement on the rotor is in a whorl pattern between the rotor end plates. The blade is slanted at angles of 45 to 90 degrees depending on locations. This means that at any given instant, there is always a portion of the blade achieving a best angle of attack against the wind. This induces lift, thus causing a turning action. The whorl of the blade is of the arctangent design with varying pitch distances.

The shaft supports the rotor assembly, journals, bearings and gears for coupling to generators.

### (3) Aerofoils

Two aerofoils with 10 degrees Angle of Attack are used to create low pressure areas within the duct. The leading edge of the aerofoil has a chord angle of 45 degrees. This is to create an updraft for the wind towards the centre of the rotor assembly.

### (4) Bearings and Gear Wheels Assembly

Bearings are used in conjunction with journals to support the turbine rotor and shaft assembly. Gears are attached at the ends of the turbine shaft for coupling to generators.

The combination of the above components and their strategic locations is vital for optimum efficiency of the Kumar RR VT Engine to achieve high torque and r.p.m.

Since the construction of the engine constitutes of only a few components, ease of manufacturing is achieved and no doubt, a very robust engine.

### DESCRIPTION OF COMPONENTS AND WORKING PRESSURE DRAWINGS

To have a perspective view of the Kumars RR VT Engine and it's workings, accompanying drawings will elaborate with precise details.

FIG. 1—illustrates the Frontal View of Engine

FIG. 2—illustrates a Cross Section [A-A] of the Engine

FIG. 3—illustrates the working pressures generated within the Engine.

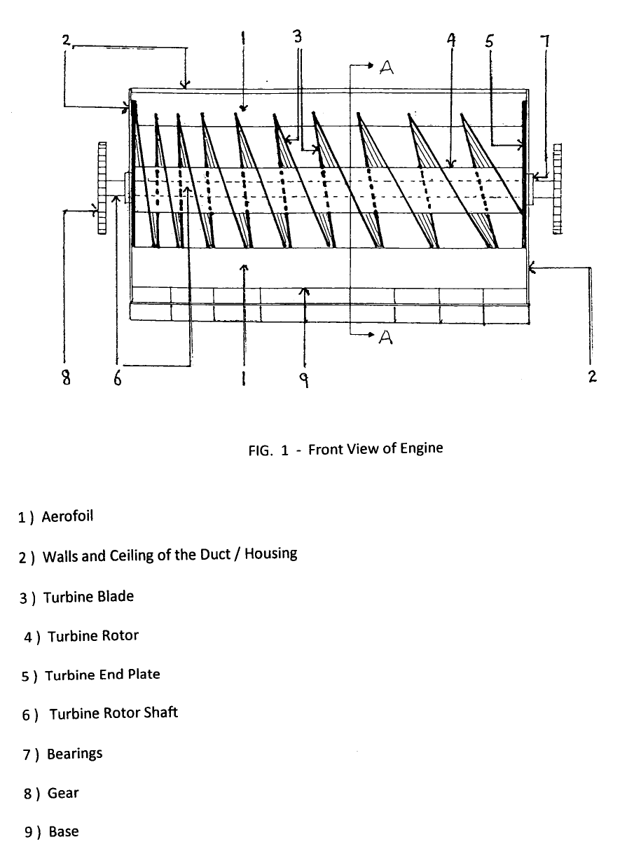

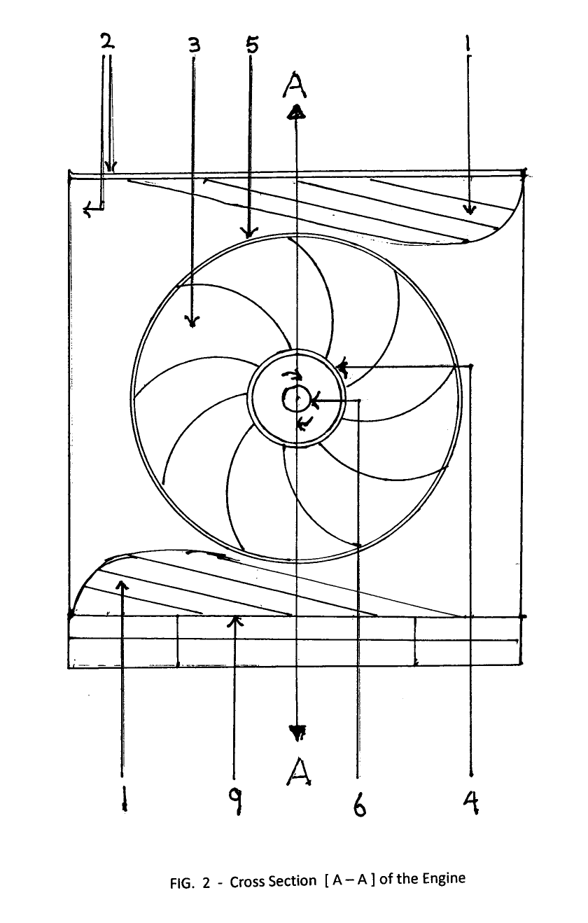

Based on the drawings, FIGS. 1, 2 and 3, it is self explanatory.

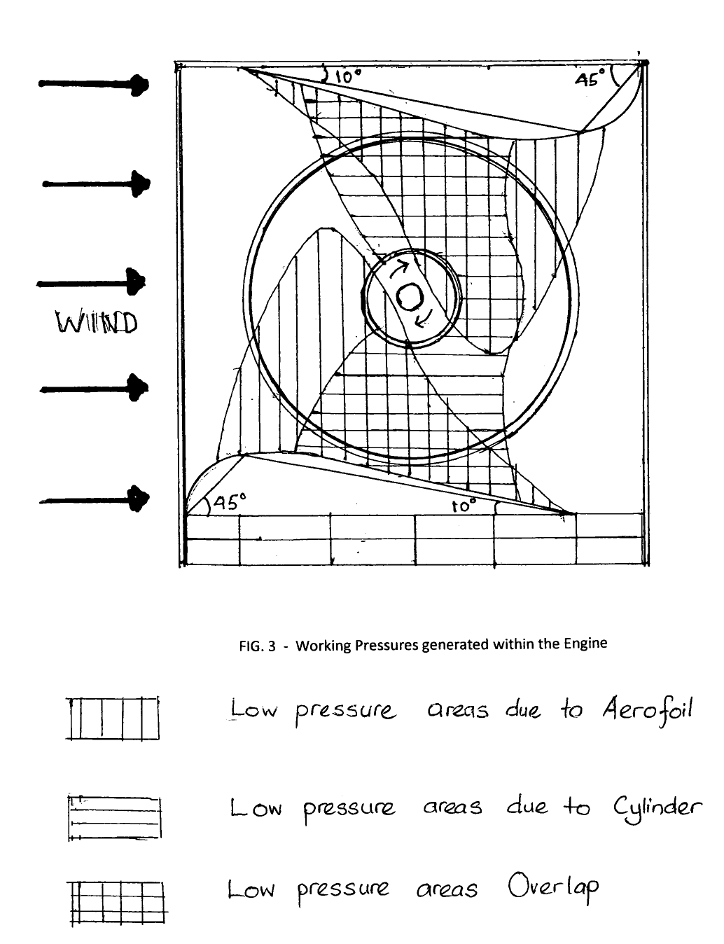

With reference to FIG. 3, it should be noted that air always tends to travel from high pressure to low pressure areas. This movement results in an increased air momentum through the engine.

1) An engine employed to harness Wind Power and converting it to Electrical Power.

2) The engine of claim 1 employs variations of pressures (FIG. 3) to operate.

3) The engine of claim 2 use fixtures such as aerofoil/s (1), cylinder/s (4), turbine blade/s (3) and endplates (5) to achieve desired pressures.

4) The components of claim 3 have to be placed strategically to fulfill the requirement of claim 2.

5) The engine of claim 4 can be mounted on a base (9) and installed anywhere.

6) The engine of claim 5 is coupled to 2 generators by gear (8) trains at the turbine shaft (6) ends.

7) The engine of claim 6 can be operated as multiple units at a single location or various Locations and the outputs localized or centralized.

8) The engine of claims 6 and 7 can be installed Horizontally, Vertically or any desired position.
